(19) United States
(12) Patent Application Publication
(10) Pub. No.: US 2006/0268115 A1
(43) Pub. Date: Nov. 30, 2006

(54) Determining distance to an object

(76) Inventors: Helmut Eggers, Ulm (DE); Gerhard Kurz, Wendlingen (DE); Jurgen Seekircher, Ostfildern (DE); Thomas Wohlgemuth, Aichtal (DE)

Correspondence Address: AKERMAN SENTERFITT, P.O. BOX 3188, WEST PALM BEACH, FL, 33402-3188, US

(21) Appl. No.: 10/572,662

(22) PCT Filed: Aug. 31, 2004
(86) PCT No.: PCT/EP04/09678

§ 371 Date: Mar. 20, 2006

(30) Foreign Application Priority Data
Sep. 19, 2003 (DE) 10343406.2

(51) Int. Cl. H04N 5/225

(52) U.S. Cl. 348/207.99

(57) ABSTRACT

A device comprising two cameras (1; 2) of which a first camera (1) is sensitive in the visible spectral range and a second camera (2) is sensitive in the infrared spectral range. The cameras (1; 2) are placed at a defined distance (a) from one another in order to record images of an identical scene (3) containing at least one object (4). The device also comprises a triangulation device (7) that calculates a distance of the object (4) from the cameras (1; 2) based on a defined distance (a) and on the images recorded by the two cameras (1; 2).

### CROSS REFERENCE TO RELATED APPLICATION

This application is a national stage of PCT/EP2004/009678 filed Aug. 31, 2004 and based upon DE 103 43 406.2 filed Sep. 19, 2003 under the International Convention.

### BACKGROUND OF THE INVENTION

1. Field of the invention

The invention is an apparatus having two cameras, of which a first camera is sensitive in the visible spectral region and a second camera is sensitive in the infrared spectral region, and that are arranged at a defined spacing from one another in order to record images of an identical scene having at least one object. The invention further relates to a method for determining distance between objects.

Increasing use is being made nowadays in motor vehicles of cameras that are sensitive in the infrared spectral region in order to enable a vehicle driver to orientate himself/herself in darkness, and to facilitate the detection of objects. Here, an image of a scene having the objects is recorded in an infrared spectral region, and there is derived from the image a display image of the scene that is displayed on a display screen. Because the radiation in the infrared wavelength region is thermal radiation, a brightness distribution in the display image of the scene corresponds to a temperature distribution in the scene such that, for example, an inscription applied to objects of the scene such as plates and information panels is not reproduced in the display image.

2. Description of Related Art

In order to eliminate this disadvantage, it is known from U.S. Pat. No. 5,100,558 and U.S. Pat. No. 6,150,930 for example, for cameras that are sensitive in the infrared spectral region to be combined with cameras that are sensitive in the visible spectral region. The image of the scene that is recorded by the camera sensitive in the infrared spectral region is overlaid in this case by an image of the scene that has been recorded by the camera sensitive in the visible spectral region such that color differences from regions of the object that radiate in the visible spectral region are visualized in the display image of the scene. In displaying images produced by such color night-vision devices, it is possible, for example, to detect the colors of traffic lights, to distinguish headlights of oncoming motor vehicles from rear spotlights and brake lights of motor vehicles traveling in front, or to render descriptions on information panels legible in the dark.

In the color night-vision device disclosed in U.S. Pat. No. 5,001,558, the infrared camera records a monochromatic image of a scene. The color camera records an image of the same scene in the visible spectral region. The two images are superimposed, and this superposition is fed to a display screen that reproduces a display image of the scene as a superposition of the two images. The arrangement is such that there is arranged between the two cameras a mirror which is reflective for radiation in the visible spectral region and transmitting to radiation in the infrared spectral region. The color camera arranged upstream of the mirror records visible radiation reflected by the mirror, while the infrared camera, arranged downstream of the mirror, records infrared radiation transmitted by the mirror. This ensures that the two cameras in each case record an image of the same scene.

A further, night vision device is disclosed in U.S. Pat. No. 6,150,930. In this document, the color night-vision device comprises only one camera, but it is fitted with different types of sensors. Thus, a first type of sensors is sensitive to infrared radiation, and a second type of sensors is sensitive to radiation in the visible spectral region. This camera can be used to produce two images of the same scene, of which one is recorded in the infrared spectral region, and the second in the visible spectral region. The two images are combined to form a display image of the scene that is displayed on a display screen.

### SUMMARY OF THE INVENTION

In modern motor vehicles, anti-collision apparatuses are also known in addition to infrared cameras or color night vision devices. These apparatuses operate, for example, with a radar sensor in order to determine the distance to a vehicle traveling in front or to an object occurring in the driving direction of the motor vehicle. If the distance is reduced to below a prescribed limiting value, the motor vehicle is automatically slightly braked. If it is increased above the limiting value, the motor vehicle is accelerated. As an alternative to this, it is possible to trigger an acoustic warning signal that indicates to a driver when he should brake sharply.

With regard to general attempts at reducing weight in motor vehicles, which favorably affect fuel consumption, inter alia, and the savings in costs, it is desirable to simplify existing devices in motor vehicles in such a way that components can be dispensed with as far as possible.

It is therefore an object of the present invention to provide an apparatus and a method for determining distance to an object which leads to component savings in a motor vehicle that is fitted with a night-vision device and an anti-collision system.

In the invention, a single apparatus is used to record two images of the same scene, one in the visible spectral region, the second in the infrared spectral region, and a distance to the object in the scene is determined from the images without additional outlay. The distance determined can be used for suitable purposes such as for an anti-collision apparatus, for example. Consequently, the need for a distance sensor such as, for example, a radar sensor is eliminated in the case of known anti-collision apparatuses. The apparatuses described in the above named documents therefore cannot be used to determine distance to objects, because the two cameras respectively record the scene from the same angle of vision such that the defined spacing required between the cameras in order to determine distance is lacking. An additional distance sensor for operating an anti-collision apparatus is indispensable for a vehicle with such an apparatus. By contrast with U.S. Pat. No. 5,001,558, the invention has the further advantage that the mirror is also eliminated, and this constitutes an additional advantage with regard to required adjusting operations on mirrors and cameras, and to the risk of breakage with mirrors. Because components such as distance sensors and/or mirrors can be saved with the apparatus according to the invention, a motor vehicle that is equipped with an inventive apparatus is generally more cost effective and of lower weight, and thus saves more fuel than known motor vehicles with a color night-vision device and anti-collision apparatus.

The apparatus can further comprise a reproduction system with a display screen for electronic production and display of a display image, constructed from a plurality of pixels, of the scene, the reproduction system deriving the display image from image signals that are supplied by the two cameras. If the first camera is a color camera, the apparatus can be used as a color night-vision device that, as described above, visualizes in the display image color differences of regions of the scene that radiate in the visual spectral region. Unpracticed persons are thereby also enabled to detect the scene on the display image without difficulty and to orientate themselves in the dark.

The reproduction system preferably comprises a combination device for producing a combined video signal and derives the display image from the combined video signal, the combined video signal comprising for each pixel an item of luminance information derived from the image signal of the second camera and an item of color information derived from the image signal of the first camera. Such a combination can be accomplished by means of simple circuits.

The first camera can supply as image signal a multi-component color video signal in which one of the components is an item of luminance information for each pixel. This corresponds to the known representation of the pixels in the YUV model.

As an alternative thereto, the first camera can comprise sensors that are respectively sensitive in a red, a green or a blue wavelength region which corresponds to the known RGB recording method. In addition, the first camera can comprise a transformation matrix that transforms signals supplied by the sensors into the multi-component color video signal, in which one of the components is an item of luminance information for each pixel. In such a case, it is possible to provide for the reproduction system a back transformation matrix that back transforms the multi-component color video signal into a second color video signal that represents the brightness of each pixel in a red, a green and a blue wavelength region, and derives the display image from the second color video signal.

The reproduction system is also capable in principle of producing a spatial image of the object.

In the case of the method according to the invention, the object can be detected in the two images by virtue of the fact that common features are found in the images of the scene that have been taken by the two cameras.

The image of the scene that has been taken by the first camera can be represented by a multi-component color video signal, it being possible for at least one component of the multi-component color video signal to be compared with the image recorded by the second camera in order to find the common features. Such a multi-component color video signal can, for example, represent the image of the scene using the known RGB model in a red, a green and a blue spectral region. It is then possible to use only a representation of the image in either the red or the green or the blue spectral region for the comparison with the image recorded by the second camera. However, it is also possible in each case to compare two or three representations, that is to say the complete multi-component color video signal, with the image recorded by the second camera. A corresponding statement is possible for a multi-component color video signal using the YUV model, whose components constitute a luminance component Y and two color components U and V, and that can be obtained by a transformation from a multi-component color video signal using the RGB model.

On the other hand, the image of the scene that has been recorded with the first camera can reproduce an item of luminance information of the scene, and this image can now be compared with the image recorded with the second camera in order to find the common features. It is then not absolutely necessary for the first camera to be a color camera; it is also possible to use a black and white camera as first camera.

### BRIEF DESCRIPTION OF THE DRAWINGS

The invention is explained in more detail below with the aid of a pictorial illustration, in which:

FIG. 1 shows a schematic design of an apparatus for carrying out the method according to the invention.

### DETAILED DESCRIPTION OF THE INVENTION

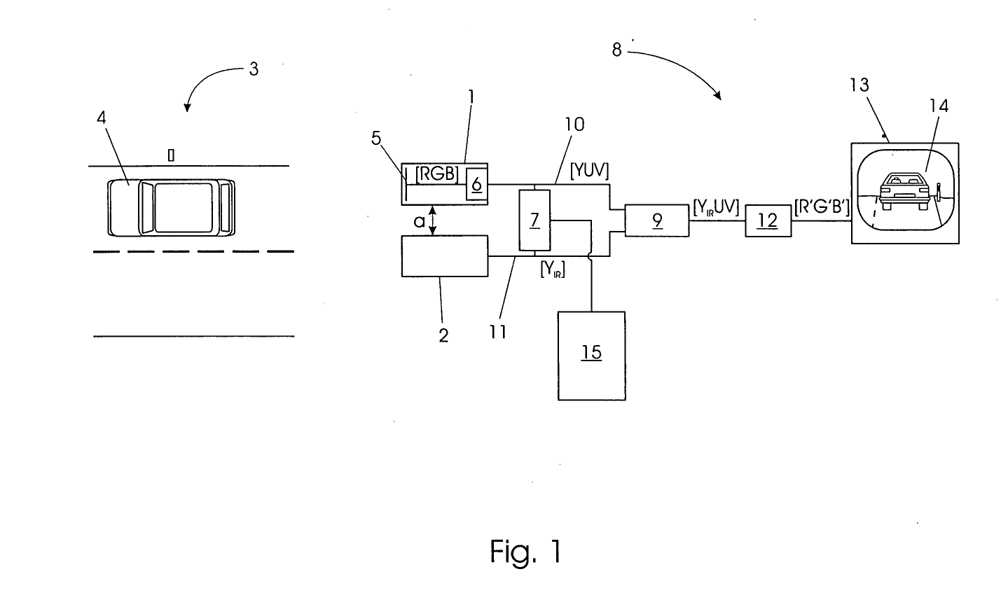

An apparatus installed in a motor vehicle for carrying out the method according to the invention is illustrated schematically in FIG. 1. The apparatus comprises a first camera 1 and a second camera 2 that are arranged at a defined spacing a from one another. The two cameras 1, 2 are aligned with a scene 3 that includes an object 4, in the present case a vehicle, and respectively record an image of the scene 3. The first camera 1 is sensitive in the visible spectral region, while the second camera 2 is visible in the infrared spectral region. Here, the first camera 1 comprises sensors 5 that are respectively sensitive in a red, a green and a blue wavelength region, and a transformation matrix 6 connected to the sensors 5. The first camera 1 and the second camera 2 are connected to a triangulation device 7. They are also connected to a reproduction system 8. The reproduction system 8 comprises a combination device 9 that is connected via a line 10 to the first camera 1, and via a line 11 to the second camera 2, a back transformation matrix 12 connected to the combination matrix 9, and a display screen 13 for displaying a display image 14. Finally, an anti-collision device 15 on the vehicle is illustrated. This is connected to the triangulation device 7.

The second camera 2 records an image of the scene 3 in the infrared wavelength region in order to carry out the method according to the invention. It produces therefrom a Y_{IR} image signal and outputs it to the line 11 via which it reaches the triangulation device 7 on the one hand, and the combination device 9, on the other hand.

The first camera 1 likewise records an image of the scene 3 with the sensors 5 in the visible spectral region. Using the RGB recording method, the sensors 5 supply the transformation matrix 6 with corresponding signals RGB of the image. The transformation matrix transforms the signals RGB into a multi-component color video signal YUV, the component Y of the multi-component color video signal YUV being a luminance signal. The following matrix multiplication is carried out for this transformation:

$$( \begin{matrix}Y \\ U \\ V\end{matrix} ) = ( \begin{matrix}0.299 & 0.587 & 0.114 \\ - 0.169 & - 0.3316 & 0.500 \\ 0.500 & - 0.4186 & - 0.0813\end{matrix} ) \cdot ( \begin{matrix}R \\ G \\ B\end{matrix} )$$

The multi-component color video signal YUV leaves the first camera 1 via the line 10 and, like the Y_{IR} image signal, reaches the triangulation device 7, on the one hand, and the combination device 9, on the other hand.

The combination device 9 combines the Y_{IR} image signal with the multi-component color video signal YUV by replacing the luminance signal Y of the multi-component color video signal YUV by the Y_{IR} image signal. A combined video signal Y_{IR}UV is obtained by replacement of the Y signal in the multi-component color video signal YUV by the Y_{IR} image signal. In this multi-component color video signal, the brightness of each pixel is defined by Y_{IR}, and its color value is defined by U and V. This Y_{IR} image signal is output by the combination device to the back transformation matrix 12.

The back transformation matrix 12 is a device that executes a transformation of the video signal which is inverse to the transformation carried out by the transformation matrix 6 of the first camera 1. In general, this back transformation is accomplished by the following matrix multiplication:

$$( \begin{matrix}R \\ G \\ B\end{matrix} ) = ( \begin{matrix}1 & 0 & 1.404 \\ 1 & - 0.3434 & - 0.712 \\ 1 & 1.773 & 0\end{matrix} ) \cdot ( \begin{matrix}Y \\ U \\ V\end{matrix} )$$

That is to say, in the present case the back transformation matrix 12 converts signals from the YUV model into the RGB model. The combined video signal Y_{IR}UV is therefore converted in the back transformation matrix 12 into a second multi-component color video signal R′G′B′ and finally output to the display screen 13. A display image 14 derived from the second multi-component color video signal R′G′B′ and constructed from pixels is reproduced by the display screen 13, the pixels of the display image 14 being displayed with a color represented by the second multi-component color video signal R′G′B′.

In addition to generating the display image 14, the multi-component color video signal YUV supplied by the first camera 1, and the Y_{IR} image signal supplied by the second camera 2 are used to determine a distance of the object 4 to the cameras 1, 2. The image represented by the multi-component color video signal YUV, and the image represented by the Y_{IR} image signal are compared with one another in the triangulation device 7. A search is made in this case for common features in the images. Such features are used to identify the object 4 in the respective images of the scene 3. Since the images have a parallax displacement as a consequence of the defined spacing a of the two cameras 1, 2, a known simple triangulation method can be applied to determine a distance between the object 4 and the cameras 1, 2, respectively the motor vehicle, from the known, defined spacing a and the parallax displacement determined from the signals representing the images.

The signals RGB produced by the sensors 5 represent three images of the scene 3 in which the scene 3 is respectively imaged in a red, in a green and a blue spectral region. Consequently, as an alternative to the above it is also possible in each case to compare one of the signals R, G or B with the Y_{IR} image signal in order to find common features and to identify the object 4 by the triangulation device 7, and to determine the distance of the object 4 to the cameras 1, 2 in the way just described. However, it is also possible to compare with the Y_{IR} image signal the image that is represented by all three signals RGB and in the case of which the image in the red spectral region, the image in the green one and the image in the blue one are jointly combined to form a color image.

The distance determined is transmitted to the collision apparatus 15. The collision apparatus 15 is prescribed a limiting value for the distance that it compares with the distance that is determined by the triangulation device 7. If the distance determined undershoots the limiting value, the collision apparatus 15 causes a correspondingly prescribed reaction.

For example, the object 4 as illustrated in FIG. 1 can be a vehicle driving in front. When the collision apparatus 15 ascertains that the distance to the vehicle driving in front undershoots the limiting value, it can therefore trigger as reaction an acoustic or optical signal that is determined as a warning for the motor vehicle driver. The signal can indicate to the driver when he should brake. Also possible are arrangements of a type such that in their case the collision apparatus 14 arbitrarily takes over the control of the motor vehicle. This can range from automatic braking or acceleration for the purpose of automatically maintaining distance up to automatic avoidance movements of the motor vehicle or an emergency stop. An emergency stop is sensible chiefly when an object 4 crops up surprisingly in the driving direction and dangerously close in front of the motor vehicle.

1. An apparatus having two cameras (1; 2), of which a first camera (1) is sensitive in the visible spectral region and a second camera (2) is sensitive in the infrared spectral region, wherein said two cameras are arranged at a defined spacing (a) from one another in order to record images of an identical scene (3) having at least one object (4), wherein said apparatus further comprises a triangulation device (7) that calculates a distance of the object (4) to the camera (1; 2) from the defined spacing (a) and the images recorded by the two cameras (1; 2).

2. The apparatus as claimed in claim 1, comprising a reproduction system (8) with a display screen (13) for electronic production and display of a display image (14), constructed from a plurality of pixels, of the scene (3), the reproduction system (8) deriving the display image (14) from image signals (RGB; YUV; Y_{IR}) that are supplied by the two cameras (1; 2).

3. The apparatus as claimed in claim 1, wherein the first camera (1) is a color camera.

4. The apparatus as claimed in claim 1, wherein the reproduction system (8) comprises a combination device (9) for producing a combined video signal (Y_{IR}UV) and derives the display image (14) from the combined video signal (Y_{IR}UV), the combined video signal (Y_{IR}UV) comprising for each pixel an item of luminance information derived from the image signal (Y_{IR}) of the second camera and an item of color information derived from the image signal (RGB; YUV) of the first camera.

5. The device as claimed in claim 4, wherein the first camera (1) supplies a multi-component color video signal (YUV) as the image signal (RGB; YUV), and in that one of the components (Y) is an item of luminance information for each pixel.

6. The apparatus as claimed in claim 5, wherein the first camera (1) comprises sensors (5) that are respectively sensitive in a red, a green or a blue wavelength region, and a transformation matrix that transforms signals (RGB) supplied by the sensors (5) into the multi-component color video signal (YUV).

7. The apparatus as claimed in claim 6, wherein the reproduction system (8) comprises a back transformation matrix (12) that transforms a multi-component color video signal (Y_{IR}UV) into a second color video signal (R′G′B′) that represents the brightness of each pixel in a red, a green and a blue wavelength region, and derives the display image (14) from the second color video signal (R′G′B′).

8. The apparatus as claimed in claim 2, wherein the reproduction system (8) produces a spatial image of the object (4).

9. A vehicle with an apparatus having two cameras (1; 2), of which a first camera (1) is sensitive in the visible spectral region and a second camera (2) is sensitive in the infrared spectral region, wherein said two cameras are arranged at a defined spacing (a) from one another in order to record images of an identical scene (3) having at least one object (4), wherein said apparatus further comprises a triangulation device (7) that calculates a distance of the object (4) to the camera (1; 2) from the defined spacing (a) and the images recorded by the two cameras (1; 2).

10. The vehicle as claimed in claim 9, wherein comprises an automatic anti-collision apparatus (15) that uses the distance calculated by the triangulation device (7).

11. A method for determining distance to an object (4), comprising:
(a) recording an image of a scene (3) having the object (4) in a visible spectral region with a first camera (1);
(b) recording an image of the same scene (3) in an infrared spectral region with a second camera (2) that is arranged at a defined spacing (a) from the first camera (1); and
(c) calculating a distance of the object (4) to the camera (1; 2) from the defined spacing (a) and the images recorded by the two cameras (1; 2).

12. The method as claimed in claim 11, the object (4) is detected in the two images by finding common features in the images of the scene (3) recorded by the two cameras (1; 2).

13. The method as claimed in claim 12, wherein the image recorded with the first camera (1) is represented by a multi-component color video signal (RGB; YUV), and at least one component of the multi-component color video signal (RGB; YUV) is compared with the image recorded by the second camera (2) in order to find the common features.

14. The method as claimed in claim 12, wherein the image, recorded with the first camera (1), of the scene (3) reproduces an item of luminance information (Y) of the scene (3), and this image is compared with the image recorded by the second camera (2) in order to find the common features.
